(19) United States
(12) Patent Application Publication
(10) Pub. No.: US 2012/0055810 A1
(43) Pub. Date: Mar. 8, 2012

(54) SOLID-STATE ELECTROCHEMICAL SENSOR

(75) Inventor: Xiangyang Zhou, Miami, FL (US)

(73) Assignee: UNIVERSITY OF MIAMI, Miami, FL (US)

(21) Appl. No.: 13/320,559

(22) PCT Filed: May 29, 2009
(86) PCT No.: PCT/US09/45642

§ 371 Date: Nov. 15, 2011

(51) Int. Cl. G01N 17/02

(52) U.S. Cl. 205/775.5; 204/404

(57) ABSTRACT

A method and system for corrosion detection. The system may comprise an electrochemical sensor having a working electrode, a reference electrode, a counter electrode, and a polymer electrolyte film containing redox pairs. The electrochemical sensor may further be engaged with a guide element. A console may be included, the console being coupled to the guide element and in electrical communication with the electrochemical sensor.

### FIELD OF THE INVENTION

The present invention relates to a method and system for corrosion detection.

### BACKGROUND OF THE INVENTION

Corrosion of materials, in particular metals, can cause serious structural failures, which may further lead to large economic loss, environmental pollution, or risk of personnel injuries. An important step to reduce the risk and prevalence of corrosion related structural failures is to detect and diagnose corrosion early, so that effective treatments can be employed. Traditionally, applying a layer of paint to a metal surface provided some protection against corrosion. However, over a period of time, the protective paint layer may lose its ability to protect the metal surface from corroding as a result of chipping, attack of organic compounds, normal wear and tear causing micro-pores to develop on the paint surface, or pre-existing micro-pores. For example, surfaces exposed to water, such as ship hulls, are particularly vulnerable to erosion due to corrosive nature of salt water. Once micro-pores form, water and oxygen may diffuse into these micro-pores and contact the metallic surface underneath the paint and enable a micro-electrochemical cell resulting in dissolution of the metal. As a result, corrosion detection is essential to detect early signs of damage to the underlying metal surface.

Under-paint or under-coating corrosion inspection and detection are one of the major areas of corrosion engineering. Current corrosion inspection technologies may be divided into two major categories: electrochemical methods and non-electrochemical methods. Non-electrochemical methods include, among other things, detecting geometric defects, moisture, or contamination by utilizing X-rays, laser spectroscopy, eddy current, magnetic current, acoustic emission, electrical current field, Fourier transform infrared spectroscopy (FTIR), etc. However, these methods may lack the resolution or sensitivity to detect corrosion in microscopic pores or be awkward for inspecting surfaces with complex geometries or may cause damage to the surfaces to be examined. Moreover, qualitative corrosion measurements, such as visual observations, do not provide reliable measurement results especially when the corrosion or contamination area is small and underneath paint.

Electrochemical methods, including linear polarization methods, electrochemical impedance methods, and electrochemical noise (potential, current, and noise resistance methods) have been routinely used for measuring exposed metallic elements, but require using bulky or liquid metallic elements as the working electrode. Additionally, current electrochemical detection methods may be inadequate and inapposite for detection of metallic corrosion under paint for aircrafts and ships, because these metallic bodies are often heavily coated with paint to prolong the lifetime of aircrafts or ships.

Moreover, fast, reliable, and easy to use electrochemical method are needed due to the prevalence of adhesive bonding in modern and future aircrafts and ships. Adhesive bonding is the joining together of two or more solids by the use of glue, cement, or other adhesive, and has been used in the manufacture and repair of primary aircraft structures for over 50 years, and may replace riveting in the major aircraft assembly lines. Polymer or composite adherand surface preparation in aircraft manufacture is a critical issue to structural integrity of bonded structures. In the absence of an in-field surface inspection method, laborious and sometimes inadequate measures are used to ensure the quality of adhesive bonding, thereby creating an undue expense on an otherwise cost-effective manufacturing process. Present detection methods are inadequate to detect and measure corrosion underneath the adherand surface for in-field applications.

Therefore, is it desirable to provide for an electrochemical system and method for corrosion detection that is light, compact, easy to use, and can detect corrosion underneath paint or a polymer or composite adherand surface.

### SUMMARY OF THE INVENTION

The present invention advantageously provides a method and system for corrosion detection. The system may comprise an electrochemical sensor having a working electrode, a reference electrode, a counter electrode. The electrochemical sensor may further be engaged with a guide element. A console may be included, the console being coupled to the guide element and in electrical communication with the electrochemical sensor.

In another embodiment, the present invention advantageously provides for a system for corrosion detection. The system may include an electrochemical sensor having a working electrode, a reference electrode, and a counter electrode, the working electrode, a reference electrode, and a counter electrode being printed onto a based and covered with a mediated polymer electrolyte doped with a redox pair. The electrochemical sensor may further be engaged with a guide element, the guide element being at least partially disposed within a housing. A console may be coupled to the guide element, the console being connected to the electrochemical sensor by one or more electrical connectors disposed within the guide element. The electrical connectors may extend from the console to the tip portion of the guide element.

In another embodiment, the present invention advantageously provides for a method for detecting corrosion. The method may include providing an electrochemical sensor having a working electrode, a reference electrode, and a counter electrode, the working electrode, a reference electrode, and a counter electrode being printed onto a based and covered with a mediated polymer electrolyte doped with a redox pair. The electrochemical sensor may further be engaged with a guide element. The method may further include positioning the guide element such that a tip portion of the guide element is proximate a surface to be examined and detecting charged particles.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an embodiment of the corrosion detection system in accordance with the principals of the present invention;

FIG. 2 is an embodiment of the corrosion detection system shown in FIG. 1;

FIG. 3 is an embodiment of the corrosion detection system in accordance with the principals of the present invention;

FIG. 4 is a side by side comparison of current recorded from use of the corrosion detection system on a clean acrylic surface compared to an acrylic surface contaminate with sulfuric acid is shown; and

FIG. 5 is an electrical impedance measurement as a function of surface moisture level is shown for the corrosion detection system.

### DETAILED DESCRIPTION OF THE INVENTION

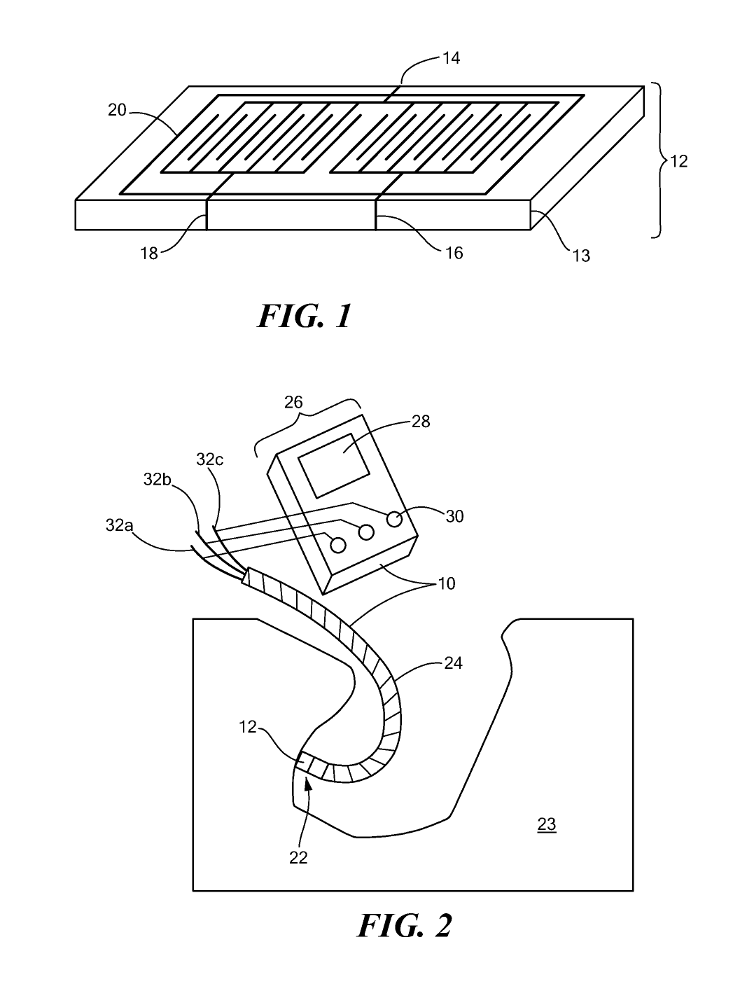

Referring now to the drawings in which like reference designators refer to like elements, there is shown in FIGS. 1 and 2 an exemplary embodiment of the corrosion detection system in accordance with the principals of the present invention and designated generally as “10.” The corrosion detection system 10 may include an electrochemical sensor 12 in operative communication with the various components of the invention discussed herein. The electrochemical sensor 12 may comprise all solid-state components. For example, Ag and Ag|AgCl lines, or similar metallic compounds, may be printed or etched on a base 13, the base 13 being a polymer or glass sheet, wafer, chip, or any other substrate. The use of solid-state components may facilitate the portability of the electrochemical sensor 12. The Ag|AgCl printed lines may be configured in a pattern, for example as shown in FIG. 1, or any other configuration of printed lines. The printed lines may be used as a reference electrode (RE) 14 (for example, Ag|AgCl), working electrode (WE) 16 (for example, Ag), and counter electrode (CE) 18 (for example, Ag). Alternatively, the solid-state components may include the WE 16 and the CE 18 without a RE 18. The arrangement of the printed lines may further increase the sensitivity of the sensor. For example, the proximity of the printed lines, such as the distance between the WE 16 and CE 18, may increase the sensitivity of the electrochemical sensor 12.

The electrodes may be further covered or disposed within a polymer electrolyte 20, which may be applied as a film to the base 13, or otherwise coupled to the base 13. The polymer electrolyte 20 may be mediated by a mediators, mediating molecules, or redox pairs. The polymer electrolyte 20 may provide for ionic conduction between the electrodes and electrical communication between or amongst any compounds in contact with the film and the WE 16. This may facilitate detection of corrosion without direct electrical contact with the metal component or surface to be examined. The polymer electrolyte 20 may be a poly(ethylene oxide) (PEO) containing lithium salt or Nafion. The polymer electrolyte 20 may then be doped with a redox pair such as, for example, Ag²⁺/Ag⁺, I₃⁻/I⁻, Mn³⁺/Mn²⁺, Fe³⁺/Fe²⁺, etc.

Now referring to FIG. 2, where an exemplary embodiment of the corrosion detection system 10 is shown. The electrochemical sensor 12 may be sized, for example, approximately 5 mm×5 mm and may further be coupled to, engaged with, other otherwise disposed within a tip portion 22 of a guide or extension element 24 or may be disposed anywhere within the guide element 24. The guide element 24 may be for example a tube and define a proximal and a distal end. The guide element 24 may further be deformable, collapsible, bendable, extendable, or telescoping, such that the tip portion 22 containing the electrochemical sensor 12 may be positioned in proximity to a surface to be examined 23. Alternatively, the guide element 24 may aspirate gas proximate the tip portion 22 and suction charged particles toward the electrochemical sensor 12.

Continuing to refer to FIG. 2, the mediated polymer electrolyte 20 on the electrochemical sensor 12 may contact, or alternatively be in electrical communication with the surface to be examined 23. For example, as shown in FIG. 2, the guide element 24 may be deflected to contact or be positioned proximal to the surface to be examined 23, which may comprise a chipped or otherwise deformed area. The presence or flow of particles resulting from corrosion or rust emitted by the corroding surface may then be aspirated by the guide element 24 and detected by the electrochemical sensor 12. Alternatively, if the electrochemical sensor 12 is positioned toward the tip portion 22, particles may be detected by the electrochemical sensor 12 with or without aspiration. The term “electrical communication” herein means the flow of ions or electrons from one element to another.

Continuing to refer to FIG. 2, a console 26, for example a potentiostat, may be included in the corrosion detection system 10 and may further be in electrical communication with the electrochemical sensor 12. The console 26 may provide electrical energy to perform cyclic voltammetry or electrochemical impedance spectroscopy measurements and may further be portable and include a display 28 to display measurements recorded from the electrochemical sensor 12. The console 26 may further include a wireless transmitter (not shown), which may transmit the recorded measurements from the console to a remote location, for example a database. Alternatively, the electrochemical sensor 12 may be disposed within, or otherwise engaged with the console 26. Additionally, one or more actuators (not shown) may be coupled to the console 26 and may further extend from the console 26 and be disposed within the guide element 24. The actuators may be used to deflect and move the guide element 24 towards the surface to be examined 23. One or more controls 30 may be defined by the console 26, the controls 30 being operably connected to the console 26. The controls 30 may operate the electrochemical sensor 12, display 28, actuators, suction, or transmit information remotely for analysis.

One or more electrical connectors 32, for example, wires, defining proximal and distal ends may be coupled to the console 26 and may be further coupled to the electrochemical sensor 12. In an embodiment, each electrical connector 32 may be connected to a particular electrode. For example, as shown in FIG. 2, a first electrical connector 32a may be electrically connected to the WE 16, a second electrical connector 32b may be electrically connected to the RE 14, and a third electrical connector 32c may be electrically connected to the CE 18. In an alternative embodiment, the electrical connectors 32 may be disposed within the guide element 24, wherein the proximal ends of the electrical connectors 32 and the guide element 24 may be coupled to the console 26 and the distal ends of the electrical connector 32 and the guide element 24 may be coupled to the electrochemical sensor 12.

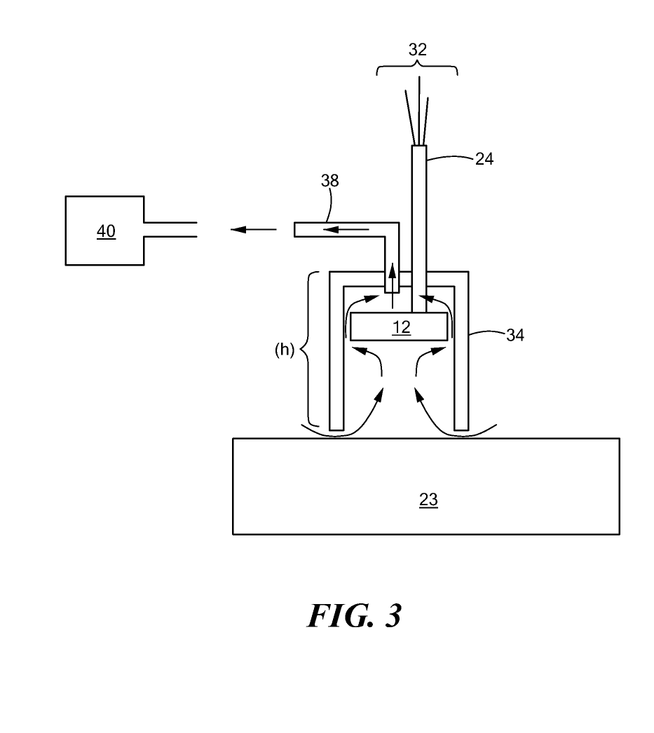

Now referring to FIG. 3, where an alternative embodiment of the corrosion detection system 10 is shown. The corrosion detection system 10 shown in FIG. 2, may further include a housing 34. The housing 34 may be composed of, for example, rubber, plastic, or any material that may at least partially enclose a volume of air. The housing 34 may further define an opening 36 such that air or gas may flow into the housing 34. As shown in FIG. 3, the housing 34 may further define a hollow interior to enclose a volume of air or gas. The housing 34 may further be sized to at least partially enclose the electrochemical sensor 12 and the guide element 24. The guide element 24 may further be coupled to the housing 34 such that movement of the guide element, for example by the actuators, may concomitantly move the housing 34. Additionally, the position of the electrochemical sensor 12 within the housing may be adjustable. For example, the guide element 24 may be slidable and moveable within the housing, such that a height (h) of the tip portion 22 and electrochemical sensor 12 disposed within the housing 34 may be adjustable.

Continuing to refer to FIG. 3, the corrosion detection system 10 may further include a conduit 38 partially disposed within the housing 34 and in fluid communication with an air pump 40. The conduit 38 may be positionable proximate the electrochemical sensor 12 such that air may be pumped from outside of the housing 34 to inside the housing 34, and out of the housing through the conduit 38. The conduit 38 may be deformable, collapsible, bendable, extendable, or telescoping such that the conduit 38 may be adjustable in response to movement of the housing 34.

In an exemplary operation, the housing 34 may be positioned proximate a surface to be examined 23. The housing 34 may contact or surround the surface to be examined 23 such that the opening 36 is sealed and air does not flow into the hollow interior. Alternatively, the housing 34 may be positioned proximate a surface to be examined 23 such that the housing 34 does not contact the surface to be examined 23 and a volume of air may flow through the opening 36 into the hollow interior. For example, the housing 34 may be positioned proximate the surface to be examined 23 by extension or movement of the guide element 24. The electrochemical sensor 12 may also be positioned at a desired height within the housing, which may modify the sensitivity of the corrosion detection system 10. The air pump 40 may then apply suction such that air contacts the electrochemical sensor 12 as it is drawn towards the conduit 38. As a result of the suction from the pump 40, corrosive ions, charged particle, surface contaminates, or surface moisture, may be drawn towards and contact the electrochemical sensor 12, which may then be detected by or react with the electrochemical sensor 12, and analyzed, displayed, or transmitted by the console 26.

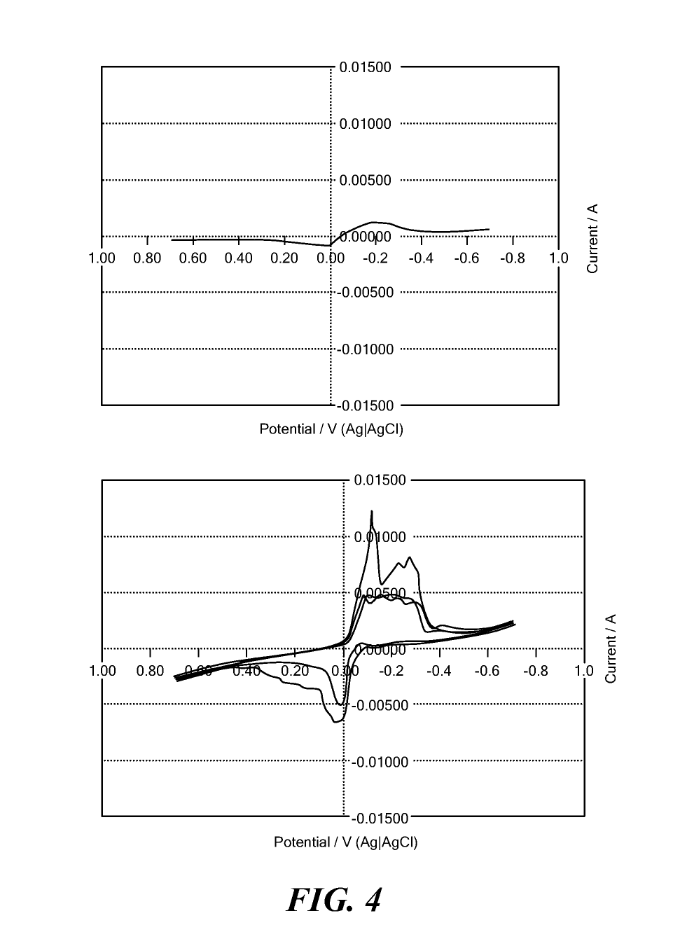

Now referring to FIG. 4, where a side by side comparison of current recorded from use of corrosion detection system 10 on a clean acrylic surface compared to an acrylic surface contaminate with sulfuric acid is shown. The x-axis represents the current measured in Amperes and the y-axis represents potential measured in Volts. A current density of 0.01 mA/cm2 was recorded as a result of cyclic voltammetry on the acrylic surface. This low current density resulting from the corrosion detection system 10 may result in a minimal destructive effect on the paint or polymer surface to be examined 23. As shown in FIG. 4, the maximum current as a function of potential divided voltage may be approximately 100 times greater for the contaminated acrylic surface (right) than that for the uncontaminated surface (left). As a result, the corrosion detection system 10 exhibits increased sensitivity to the charged particles emitted from corroding surfaces.

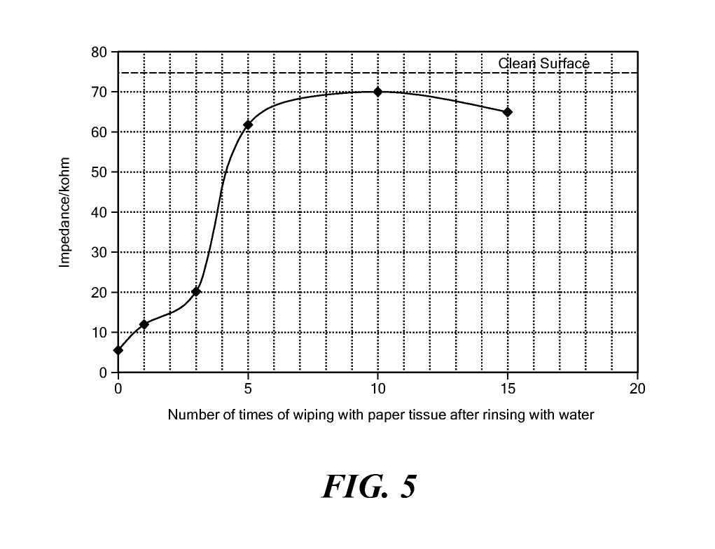

Now referring to FIG. 5, where an electrical impedance measurement as a function of surface moisture level is shown for the corrosion detection system 10. The x-axis represents impedance measured in kohms and the y-axis represents the number of times of wiping the surface with a paper tissue after the surface had been rinsed with water. An acrylic plastic sample may be cleaned and dried in a vacuum and then rinsed with water. The data shows that wiping with a paper tissue may not result in the same dryness when compared to a clean dry surface. These results further demonstrate that the electrochemical sensor 12 may also be sensitive to surface moisture levels in addition to charged metallic particles.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A corrosion detection system comprising:
an electrochemical sensor having a working electrode, a reference electrode, and a counter electrode, the electrochemical sensor being engaged with a guide element; and
a console coupled to the guide element, the console being in electrical communication with the electrochemical sensor.

2. The corrosion detection system of claim 2, wherein the working electrode, reference electrode, and counter electrode are coupled to a base.

3. The corrosion detection system of claim 2, wherein the working electrode, reference electrode, and counter electrode are covered with a mediated polymer electrolyte doped with a redox pair.

4. The corrosion detection system of claim 3, wherein the working electrode, reference electrode, and counter electrode are printed onto the base.

5. The corrosion detection system of claim 1, further comprising one or more electrical connectors disposed within the guide element, the electrical connectors being coupled to the electrochemical sensor and the console.

6. The corrosion detection system of claim 1, wherein the guide element is deformable.

7. The corrosion detection system of claim 6, further comprising one or more actuators coupled to the console, the actuators being disposed within the guide element.

8. The corrosion detection system of claim 1, wherein the guide element is slideably connected to a housing.

9. The corrosion detection system of claim 8, further comprising a pump creating suction and having a conduit, the conduit being at least partially disposed within the housing.

10. A corrosion detection system comprising:
an electrochemical sensor having a working electrode, a reference electrode, and a counter electrode, the working electrode, a reference electrode, and a counter electrode being printed onto a based and covered with a mediated polymer electrolyte doped with a redox pair, the electrochemical sensor being engaged with a guide element, wherein the guide element is at least partially disposed within a housing; and
a potentiostat coupled to the guide element, the potentiostat being in electrical communication with the electrochemical sensor.

11. The corrosion detection system of claim 10, wherein the housing partially encloses a volume of gas.

12. The corrosion detection system of claim 10, wherein the guide element is slidably connected to the housing.

13. The corrosion detection system of claim 10, further comprising a pump having a conduit, the conduit being at least partially disposed within the housing.

14. The corrosion detection system of claim 13, wherein the conduit is in fluid communication with the volume of gas partially enclosed within the housing.

15. The corrosion detection system of claim 10, wherein the guide element is deformable.

16. A method for detecting corrosion comprising:
providing an electrochemical sensor having a working electrode, a reference electrode, and a counter electrode, the working electrode, a reference electrode, and a counter electrode being covered with a mediated polymer electrolyte doped with a redox pair, the electrochemical sensor being disposed within a guide element, the guide element being partially disposed within a housing;
positioning the guide element and the housing such that a tip portion of the guide element is proximate a surface to be examined;
detecting charged particles in proximity of the electrochemical sensor.

17. The method of claim 16, further comprising measuring a current generated from the electrochemical sensor.

18. The method of claim 16, further comprising actuating the guide element such that the guide element deforms.

19. The method of claim 18, further comprising positioning the housing proximate the surface to examined such that a volume of gas is partially enclosed within the housing.

20. A corrosion detection system comprising:
an electrochemical sensor having a working electrode, a reference electrode, and a counter electrode, the working electrode, a reference electrode, and a counter electrode being printed onto a based and covered with a mediated polymer electrolyte doped with a redox pair, the electrochemical sensor being engaged with a deformable guide element, wherein the guide element is at least partially disposed within and slideably connected to a housing;
a pump creating suction and having a conduit engaged with and partially disposed within the housing, the pump being in fluid communication with a volume of gas enclosed by the housing;
a potentiostat coupled to the guide element, the potentiostat being in electrical communication with the electrochemical sensor.
